(19) United States
(12) Patent Application Publication
(10) Pub. No.: US 2025/0319815 A1
(43) Pub. Date: Oct. 16, 2025

(54) SYSTEMS, METHODS, AND PROGRAM PRODUCTS FOR PROVIDING DRIVER-SPECIFIC INFORMATION TO DRIVERS

(71) Applicant: Torc Robotics, Inc., Blacksburg, VA (US)

(72) Inventors: Maximilian Koeper, Blacksburg, VA (US); Margarita Kunjavskaja, Blacksburg, VA (US); Maximilian Yassine Beyen, Blacksburg, VA (US); Marat Kopytjuk, Blacksburg, VA (US); Simon Bäuerle, Blacksburg, VA (US)

(21) Appl. No.: 18/631,784

(22) Filed: Apr. 10, 2024

(51) Int. Cl. B60Q 1/50; G06T 11/60; G06V 20/58; G08G 1/0955; G08G 1/16; G09G 3/00

(52) U.S. Cl. CPC B60Q 1/5037; G06T 11/60; G06V 20/58; G08G 1/0955; G09G 3/001; G06V 2201/08; G08G 1/167; G09G 2380/10

(57) ABSTRACT

Systems for providing driver-specific information are disclosed. The system includes a moving display vehicle including a plurality of sensors and a multi-view display (MVD) positioned thereon. The system also includes a computing device(s) operably coupled to the sensor and the MVD and is configured to identify driver vehicle(s) within a vicinity of the display vehicle using the sensors. Additionally, the computing device(s) is configured to detect driver data for the identified driver vehicle(s) and compare the detected driver data to operational parameters for the display vehicle. The computing device(s) then creates driver-specific information for each of the identified driver vehicle(s) and communicates the information to the MVD for displaying. Where multiple driver vehicles are identified by the computing device(s) and sensors of the display vehicle, driver-specific information is created for each driver vehicle and simultaneously displayed on the MVD.

### TECHNICAL FIELD

The field of the disclosure relates generally to providing information to drivers, and more particularly, to systems, methods, and program products for providing driver-specific information to drivers using a multi-view display (MVD) positioned on a moving display vehicle.

### BACKGROUND OF THE INVENTION

Information for drivers is widely used on nearly all highways and roadways. This information spans from traffic accidents and driving-based warnings to advertisements for goods and services offered on the roadway. For example, many highways include digital message boards hanging above predetermined areas of the highway providing drivers with information relating to road construction, accidents ahead, or even travel times to up-coming exits/towns. However, these digital message boards are static and can only provide information for the area directly adjacent or directly ahead of the digital message board. Mobile message boards powered by generators are also used for providing information to drivers on highways and roadways, but they too also have similar shortcomings. Like the hanging message boards, the mobile message boards are only able to provide information relating to the area directly adjacent where the mobile message board is positioned. Additionally, although mobile, it takes time and manpower for these message boards to be moved to a desired location before any information can be provided to drivers. Furthermore, conventional message boards utilized on highways and roadways are limited in the information it provides. That is, the information displayed is limited to information that applies to all drivers and is not capable of being dynamic or customizable for each individual driver on the roadway.

It would be beneficial to have a system capable of providing dynamic information to various drivers on an individual basis, where the system is easily transportable and can provide such dynamic information based on the roadway surrounds of the system.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed provides a method for providing driver-specific information to a driver of a vehicle, where the method includes: identifying, via at least one sensor positioned on a moving display vehicle, at least one driver vehicle traveling within a predetermined vicinity of the moving display vehicle; continuously detecting, via the at least one sensor positioned on the moving display vehicle, driver data for the at least one identified driver vehicle; comparing the continuously detected driver data for the at least one identified driver vehicle to operational parameters for the moving display vehicle; creating the driver-specific information for the at least one identified driver vehicle based on the comparing of the continuously detected driver data for the at least one identified drive vehicle and the operational parameters for the moving display vehicle; displaying the driver-specific information on a multi-view display (MVD) positioned on the moving display vehicle for the at least one identified driver vehicle; and adjusting display parameters of the MVD to display the driver-specific information on the MVD as the at least one identified driver vehicle moves relative to the moving display vehicle.

In another aspect, the disclosed provides a computer program product stored on a non-transitory computer-readable storage medium, which when executed by a computing system, provides driver-specific information to a driver of a vehicle. The computer program product includes program code for: identifying, via at least one sensor positioned on a moving display vehicle, at least one driver vehicle traveling within a predetermined vicinity of the moving display vehicle; continuously detecting, via the at least one sensor positioned on the moving display vehicle, driver data for the at least one identified driver vehicle; comparing the continuously detected driver data for the at least one identified driver vehicle to operational parameters for the moving display vehicle; creating driver-specific information for the at least one identified driver vehicle based on the comparing of the continuously detected driver data for the at least one identified drive vehicle and the operational parameters for the moving display vehicle; displaying the driver-specific information on a multi-view display (MVD) positioned on the moving display vehicle for the at least one identified driver vehicle; and adjusting display parameters of the MVD to display the driver-specific information on the MVD as the at least one identified driver vehicle moves relative to the moving display vehicle.

In yet another aspect, the disclosed provides a system including: a moving display vehicle including: a plurality of sensors positioned on an exterior of the display vehicle; and a multi-view display (MVD) positioned on the moving display vehicle; and at least one computing device operably coupled to the plurality of sensors and the MVD of the moving display vehicle, the at least one computing device configured to provide driver-specific information to a driver of a vehicle by performing processes including: identifying, via the plurality of sensors of the moving display vehicle, at least one driver vehicle traveling within a predetermined vicinity of the moving display vehicle; continuously detecting, via the at least one sensor positioned on the moving display vehicle, driver data for the at least one identified driver vehicle; comparing the continuously detected driver data for the at least one identified driver vehicle to operational parameters for the moving display vehicle; creating the driver-specific information for the at least one identified driver vehicle based on the comparing of the continuously detected driver data for the at least one identified drive vehicle and the operational parameters for the moving display vehicle; displaying the driver-specific information on the MVD positioned on the moving display vehicle for the at least one identified driver vehicle; and adjusting display parameters of the MVD to display the driver-specific information on the MVD as the at least one identified driver vehicle moves relative to the moving display vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1A shows an aerial view of a display vehicle and driver vehicles, according to an example.

FIG. 1B shows a front view of a multi-view display (MVD) displaying driver-specific information for a driver vehicle of FIG. 1A, according to an example.

FIGS. 1C-1E shows aerial views of the display vehicle and driver vehicles of FIG. 1A, according to an example.

FIG. 2 shows a front view of MVD displaying driver-specific information for a driver vehicle, according to another example.

FIG. 3A shows an aerial view of a display vehicle and driver vehicles, according to a further example.

FIG. 3B shows a front view of an MVD displaying driver-specific information for the driver vehicle of FIG. 3A, according to an example.

FIG. 4A shows an aerial view of a display vehicle and driver vehicles, according to additional examples.

FIG. 4B shows a front view of an MVD displaying first driver-specific information for a first driver vehicle of FIG. 4A, according to an example.

FIG. 4C shows a front view of an MVD displaying second driver-specific information for a second driver vehicle of FIG. 4A, according to an example.

FIG. 4D shows an aerial view of the display vehicle and driver vehicles of FIG. 4A, according to the example.

FIG. 4E shows a front view of the MVD displaying the first driver-specific information for the first driver vehicle of FIG. 4D, according to an example.

FIG. 4F shows a front view of the MVD displaying the second driver-specific information for the second driver vehicle of FIG. 4D, according to an example.

FIG. 4G shows an aerial view of the display vehicle and driver vehicles of FIG. 4D, according to the example.

FIG. 5A shows an aerial view of a display vehicle and driver vehicles, according to further examples.

FIG. 5B shows a front view of an MVD displaying first driver-specific information for a first driver vehicle of FIG. 5A, according to an example.

FIG. 5C shows a front view of a distinct MVD displaying second driver-specific information for a second driver vehicle of FIG. 5A, according to an example.

FIGS. 5D and 5E show front views of distinct MVD displaying second driver-specific information for a second driver vehicle of FIG. 5A, according to additional examples.

FIG. 6A shows an aerial view of a display vehicle and driver vehicle, according to another example.

FIG. 6B shows a front view of an MVD displaying driver-specific information for a driver vehicle of FIG. 6A, according to an example.

FIG. 7 shows a flowchart illustrating a process for providing driver-specific information to a driver of a vehicle, according to an example.

FIG. 8 shows a schematic view of a computing system including a computing device(s) configured to provide driver-specific information to a driver of a vehicle, according to an example.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as a single part may include and be referenced in another context as consisting of multiple components. Alternatively, what may be described herein as including multiple components may be referred to elsewhere as a single part.

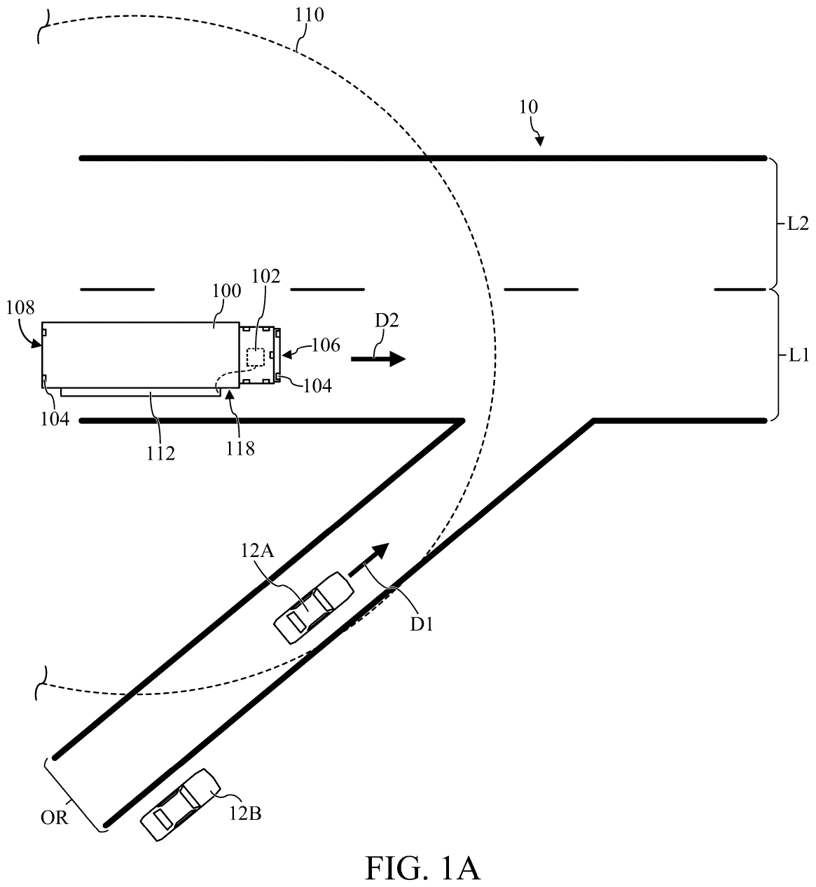

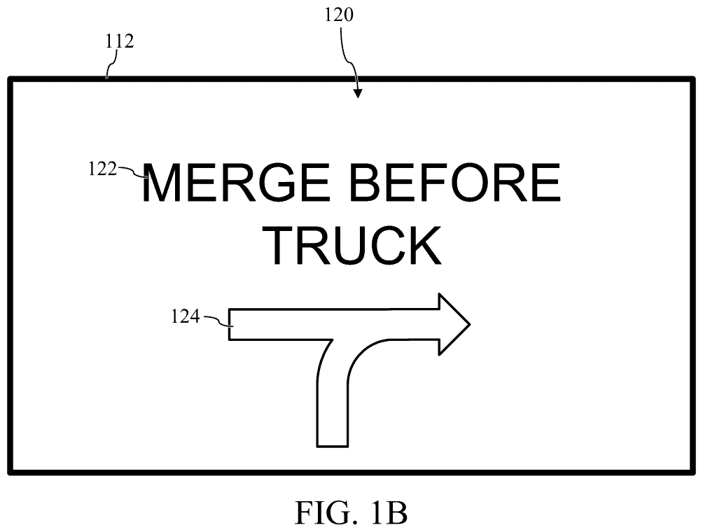

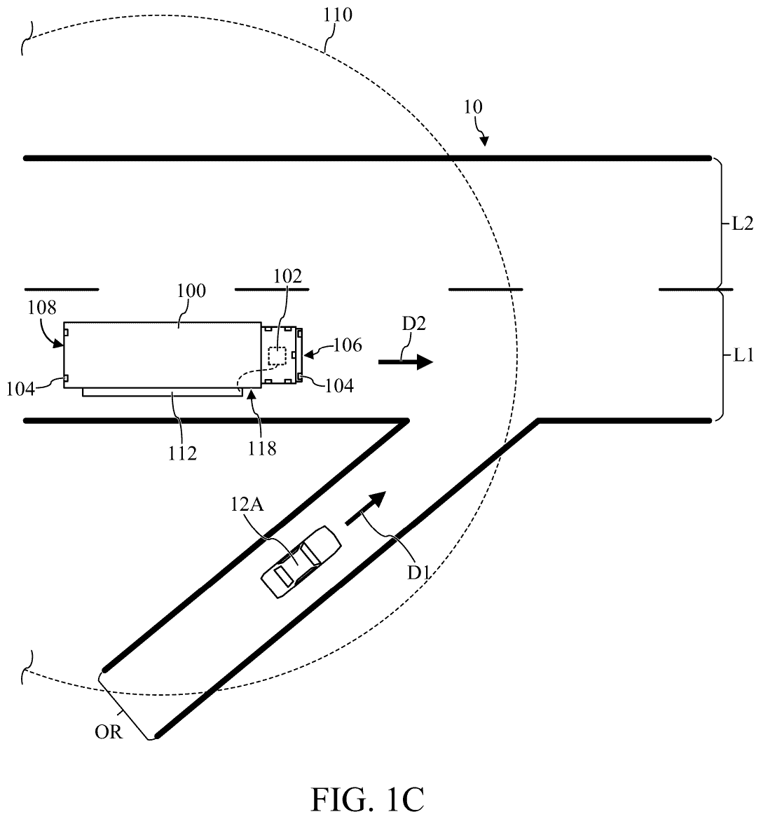

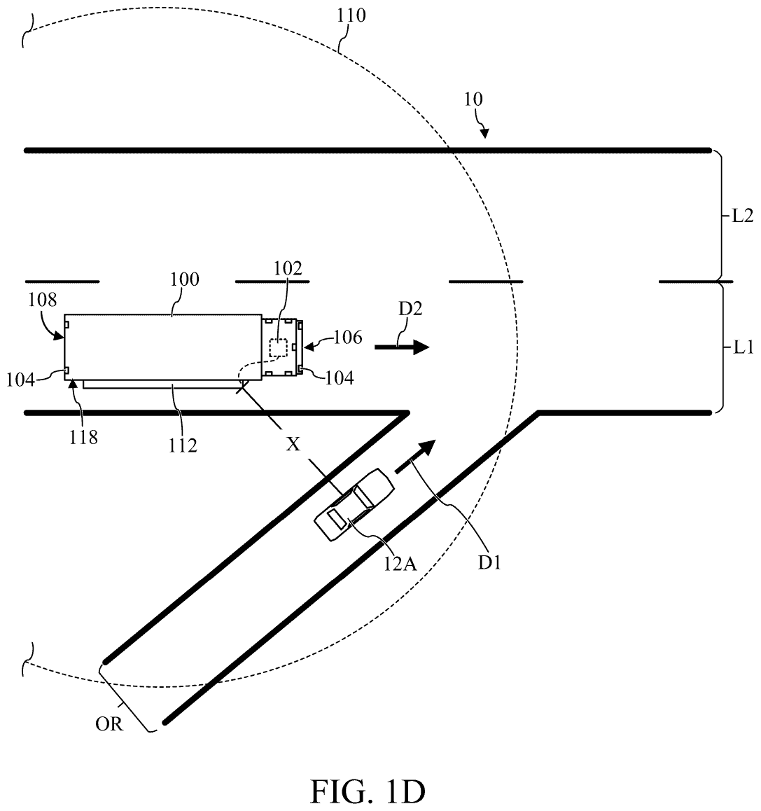

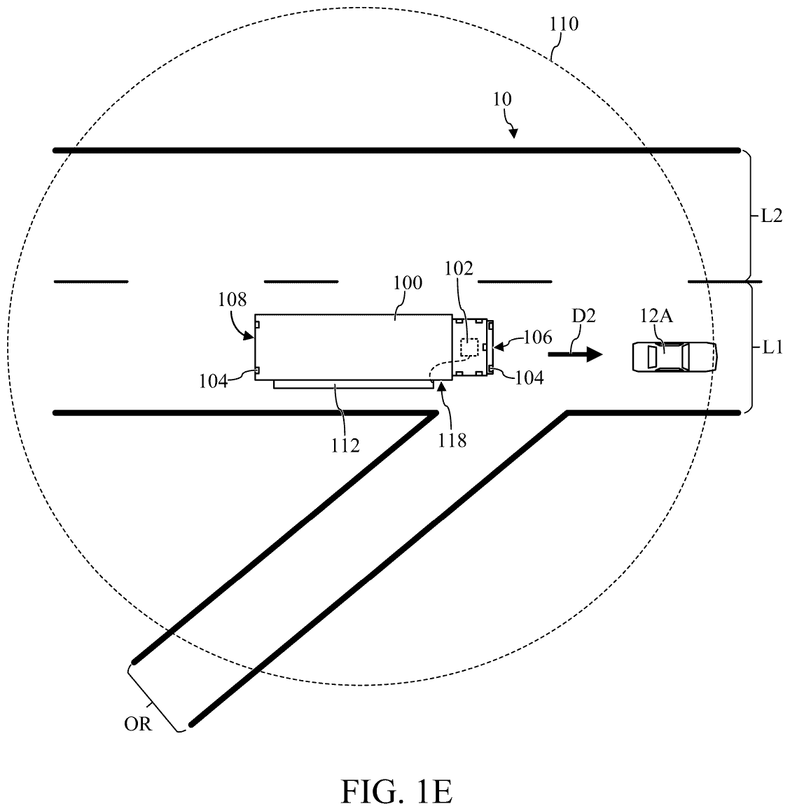

As discussed herein, the disclosure relates generally to providing information to drivers, and more particularly, to systems, methods, and program products for providing driver-specific information to drivers using a multi-view display (MVD) positioned on a moving display vehicle. These and other examples are discussed below with reference to FIGS. 1A-8.

FIG. 1A shows an aerial view of a portion of a road 10 including at least one driver vehicle 12A, 12B and a moving display vehicle 100 (hereafter, “display vehicle 100”). In the example, road 10 includes a first lane (L1), a second lane (L2) formed adjacent first lane (L1), and entry lane or on-ramp (OR) that joins and/or merges with first lane (L1). As shown, driver vehicle 12A is traveling on the on-ramp (OR) of road 10 in a direction (D1), with the intention of merging into first lane (L1) of road 10. Driver vehicle 12B is located on a shoulder of on-ramp (OR) and is stationary or parked. In the non-limiting example shown in FIG. 1A, driver vehicles 12A, 12B are passenger cars or vehicles that are piloted or controlled by a driver. In other non-limiting examples, driver vehicles 12A, 12B can include any road-approved vehicle including motorcycles, box-trucks, tractor-trailers, and the like. Additionally, although discussed herein as being controlled by a driver, it is understood that driver vehicles 12A, 12B can include an autonomous vehicle as well.

Display vehicle 100 is traveling along road 10 in a direction (D2). Specifically, display vehicle 100 is traveling or moving in a direction (D2) within first lane (L1), adjacent second lane (L2) and entry lane or on-ramp (OR) of road 10. In a non-limiting example, display vehicle 100 is an autonomous or self-driving vehicle (e.g., autonomous cargo truck). In other non-limiting examples, display vehicle 100 is a piloted vehicle that includes a driver controlling display vehicle 100. As shown in FIG. 1, display vehicle 100 is approaching, but has not yet passed or intersected with on-ramp (OR) of road 10.

As shown in FIG. 1A, display vehicle 100 includes at least one computing device 102. The at least one computing device 102 is electronically coupled and/or communicatively connected to various systems and/or components of display vehicle 100. For example, computing device 102 is communicatively coupled to a system configured to control, monitor, and/or adjust the speed and acceleration of display vehicle 100 (e.g., cruise control system, engine, fuel injector, and the like). Additionally in the example, computing device 102 is connected to a separate system, or alternatively includes a sub-system or computer program product, that functions or operates as an internal advanced driver assistance system (ADAS). As discussed herein, the ADAS communicating with, or included within, computing device 102 can monitor driver vehicles 12A, 12B and/or other objects surrounding display vehicle 100 as it travels along road 10. In additional to an ADAS, a global positioning system (GPS) is communicatively coupled to, or alternatively included within, computing device 102. GPS system for display vehicle 100 tracks the position of display vehicle 100, provides desired routes based on the destination of display vehicle 100, tracks/monitors traffic patterns for other driver vehicles on road 10, includes map data relating to road 10, and monitors/obtains other suitable information relating to the routes of travel for display vehicle 100. In the non-limiting example where display vehicle 100 is an autonomous truck, the GPS system in communication with computing device 102 influences and/or determines operational parameters of display vehicle 100 as display vehicle 100 travels from a starting location to a final destination.

Computing device 102 of display vehicle 100 can include additional suitable sub-systems and/or computer program products to monitor, determine, and/or received data relating to operational parameters for display vehicle 100. Operational parameters for display vehicle 100 include, but are not limited to, a location of display vehicle 100 with respect to road 10, a direction of travel for display vehicle 100 on road 10, future navigational information for display vehicle 100, traffic patterns surrounding display vehicle 100, maps for roadways traveled on by display vehicle 100, speed/acceleration of display vehicle 100, and/or a size of display vehicle 100. As discussed herein, computing device 102, along with operational parameters of display vehicle 100, is configured to provide driver-specific information to the driver/passengers of driver vehicle 12A, 12B.

Display vehicle 100 also includes at least one sensor 104. In the non-limiting example, display vehicle 100 includes a plurality of sensors 104 positioned around and/or disposed on various portions of display vehicle 100. As shown in the example in FIG. 1A, sensors 104 are disposed on, positioned on, and/or coupled to an exterior of display vehicle 100, adjacent to a front end 106 of display vehicle 100, and adjacent a back end 108 of display vehicle 100. The plurality of sensors 104 included on display vehicle 100 are utilized in conjunction with the ADAS and/or computing device 102 of display vehicle 100. That is, sensors 104 obtain, gather, and/or receive data regarding surrounding driver vehicles 12A, 12B and/or objects positioned adjacent display vehicle 100 as display vehicle 100 travels along road 10. The data obtained by sensors 104 are processed by the ADAS and/or computing device 102 and is utilized in providing driver-specific information to driver vehicles 12A, 12B, and/or adjusts operational parameters of display vehicle 100, as discussed herein. Sensors are 104 are configured as any suitable sensor that is capable of obtaining data that can be utilized by the ADAS and/or computing device 102 of display vehicle 100. For example, sensors 104 are formed as long-range radio wave sensors, lidar sensors, cameras, short/medium range radio wave sensors, ultrasonic sensors, and/any other suitable sensor capable of providing data as discussed herein.

Sensors 104 of display vehicle 100, at least in part, define a predetermined detection area or vicinity 110 of displayed vehicle 100. Predetermined detection vicinity 110 is an area surrounding display vehicle 100 in which sensors 104 can obtain data about driver vehicles 12A, 12B and/or objects adjacent road 10. The size of predetermined detection vicinity 110 is dependent, at least in part on, the types of sensors 104, the number of sensors 104, and/or the position or placement of sensors 104 on display vehicle 100. As discussed herein, driver vehicles 12A, 12B detected within the predetermined detection vicinity 110 of display vehicle 100 can be provided with driver-specific information.

Sensors 104 positioned on display vehicle 100 collect, detect, monitor, and/or gather driver data for driver vehicles 12A, 12B detected and/or identified within predetermined vicinity 110 of display vehicle 100. Driver data for driver vehicles 12A, 12B can include, but are not limited to, a location of the identified driver vehicle 12A, 12B, a direction of travel for the identified driver vehicle 12A, 12B, a speed/acceleration for driver vehicle 12A, 12B, a size of the identified driver vehicle 12A, 12B, or any other suitable data that is utilized by computing device 102 of display vehicle 100 for creating driver-specific information that can be subsequently displayed to the driver vehicle 12A, 12B, as discussed herein.

In the non-limiting example shown in FIG. 1A, display vehicle 100 also includes at least one multi view display (MVD) 112. MVD 112 is positioned on and/or affixed to at least a portion of display vehicle 100. In the example, MVD 112 is positioned on a side 118 of display vehicle 100. In other examples discussed herein, MVD 112 can be positioned on different portions of display vehicle 100 (e.g., back end 108), and/or display vehicle 100 can include a plurality of MVDs 112 positioned on distinct portions of vehicle 100. MVD 112 is electronically coupled to and/or operatively communicative with computing device 102 of display vehicle 100. As discussed herein, computing device 102 can obtain driver data detected by sensors 104 and process operational parameters of moving display vehicle 100, create driver-specific information 120 (see, FIG. 1B) for driver vehicle 12A, 12B sensed by sensors 104, and subsequently display the driver-specific information on MVD 112. MVD 112 is formed as any suitable electronic display device or monitor that is capable of displaying two or more sets of driver-specific information on a single display, dependent upon the position of the driver vehicle 12A, 12B with respect to MVD 112. That is, and as discussed herein, MVD 112 can simultaneously display different information, images, and/or graphics to different driver vehicles 12A, 12B that are at different viewing locations, distances, and/or angles with respect to the MVD 112. Additionally, as discussed herein, the distinct driver-specific information 120 displayed and visually presented to each distinct driver vehicle 12A, 12B are displayed in the same area of MVD 112 (e.g., overlapping). The different driver-specific information 120 can be simultaneously displayed on MVD 112 through us of a plurality of pixels forming MVD 112 that have controllable light rays capable of adjusting emitting angle, color, brightness, and/or intensity based on a viewing angle of MVD 112.

Turning to FIGS. 1A-1E, a non-limiting example of displaying driver-specific information 120 to driver vehicle 12A is shown and discussed herein. Driver vehicle 12A is traveling in a direction (D1) along on-ramp (OR) of road 10, and display vehicle 100 is traveling in a direction (D2) in first lane (L1) of road 10, between on-ramp (OR) and second lane (L2). It is driver vehicle's 12A intention to merge into first lane (L1) and travel along road 10. To do so safely, driver vehicle 12A must merge into first lane (L1) before or after display vehicle 100. In the example discussed herein, the provided driver-specific information 120 displayed on MVD 112 of display vehicle 100 can include information and/or instructions on how and/or when to merge into first lane (L1).

Sensors 104 of display vehicle can identify driver vehicle 12A is traveling within a predetermined vicinity 110 of display vehicle 100. More specifically, and as shown in the non-limiting example of FIG. 1A, sensors 104 can identify and/or determine that driver vehicle 12A is within the predetermined detection vicinity 110 of display vehicle 100 based on detection capabilities and/or functionality of sensors 104. Once identified as being within predetermined vicinity 110 of display vehicle 100, sensors 104 can continuously detect driver data for the identified driver vehicle 12A travelling within predetermined vicinity 110. In addition to sensors 104, computing device 102 of displayed vehicle 100 can also aid in the detection, obtaining, and/or determining of driver data for driver vehicle 12A within predetermined vicinity 110. For example, based on continuous detection by sensors 104 formed as cameras, computing device 102 of display vehicle 100 can detect, determine, and/or calculate a speed and/or acceleration of driver vehicle 12A as it travels along on-ramp (OR) of road 10. In the example, photos and/or videos captured by the cameras (e.g., sensors 104) included on display vehicle 100 can be continuously provided to computing device 102, and computing device 102 can calculate the speed/acceleration of driver vehicle 12A. Images captured by the cameras forming sensors 104, used in conjunction with other internal systems of display vehicle 100 (e.g., GPS system), can be used to detect, determine, and/or obtain additional driver data for vehicle 12A that includes a location of driver vehicle 12A on road 10, a direction (D1) of travel for driver vehicle 12A, an anticipated path of travel or trajectory for driver vehicle 12A, and/or an approximate size of driver vehicle 12A. As discussed herein, the continuously detected driver data for driver vehicle 12A is utilized in creating driver-specific-information 120 that is displayed on MVD 112 of display vehicle 100 for driver vehicle 12A.

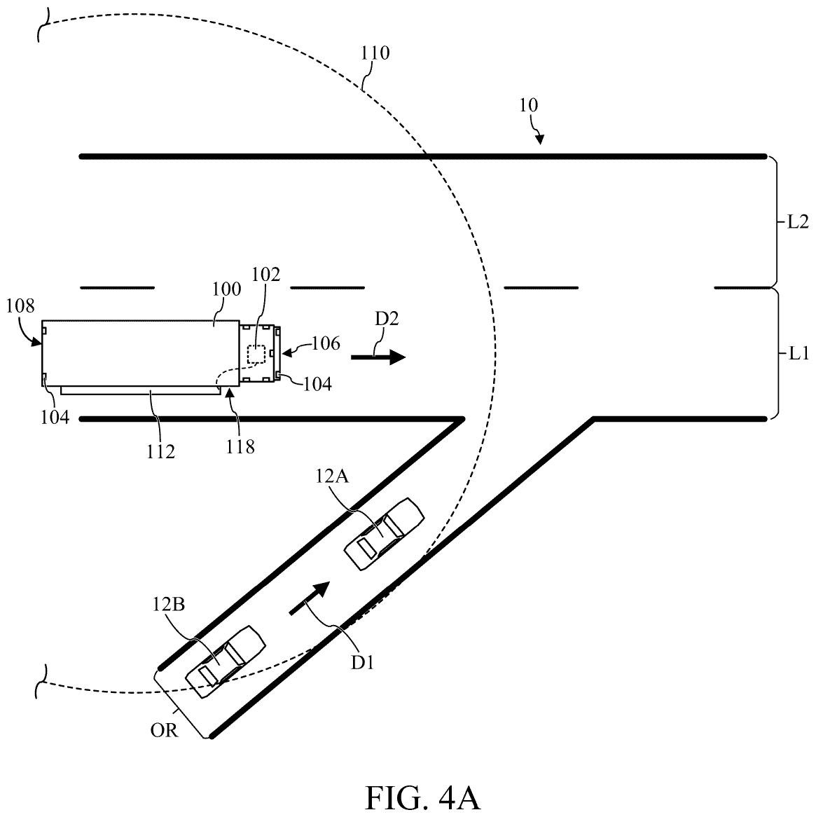

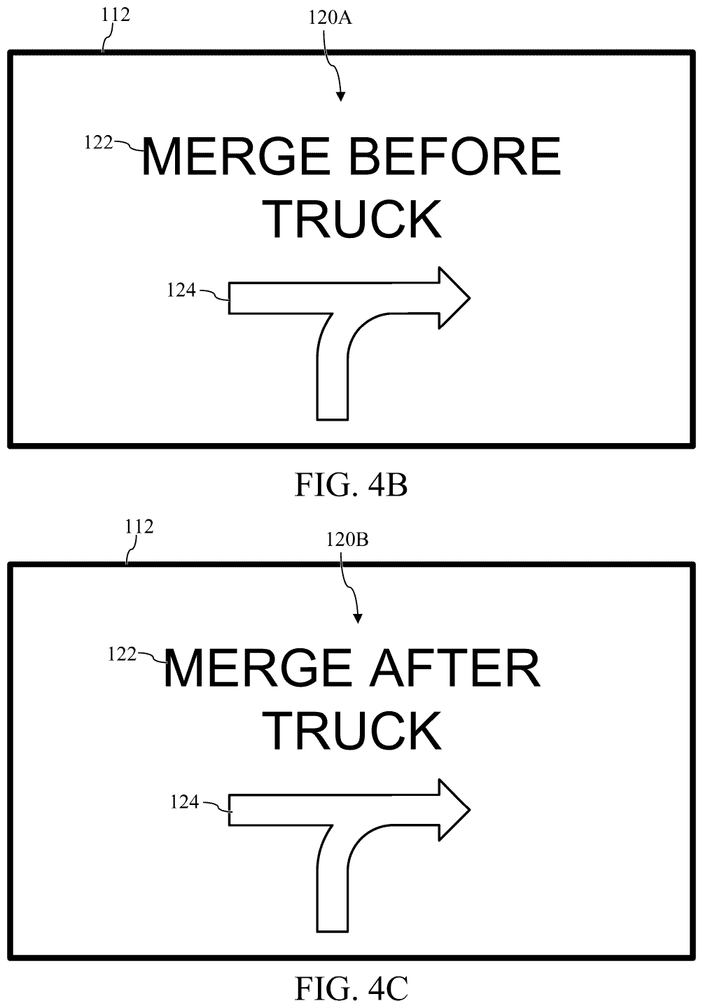

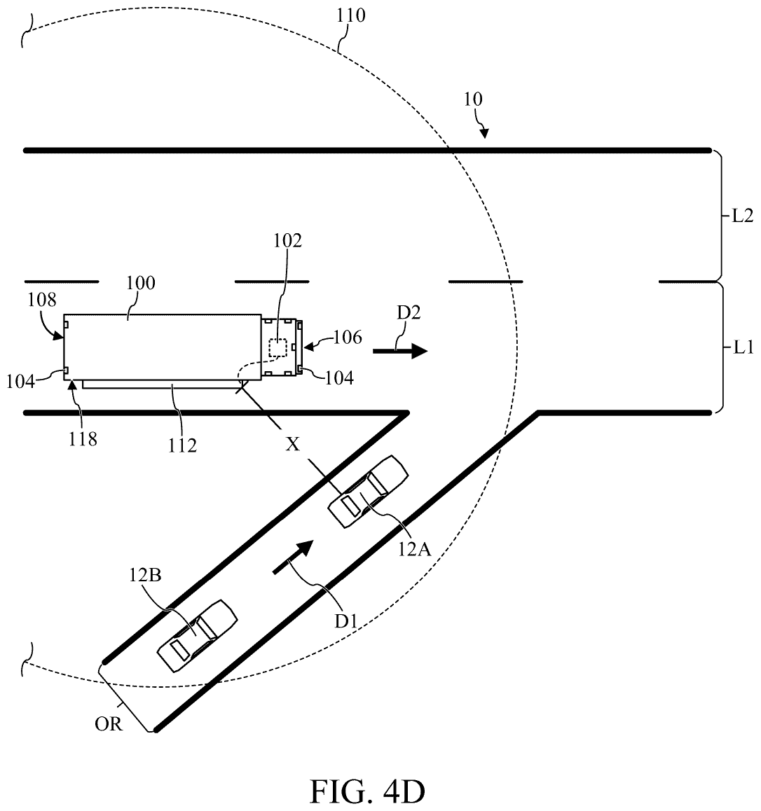

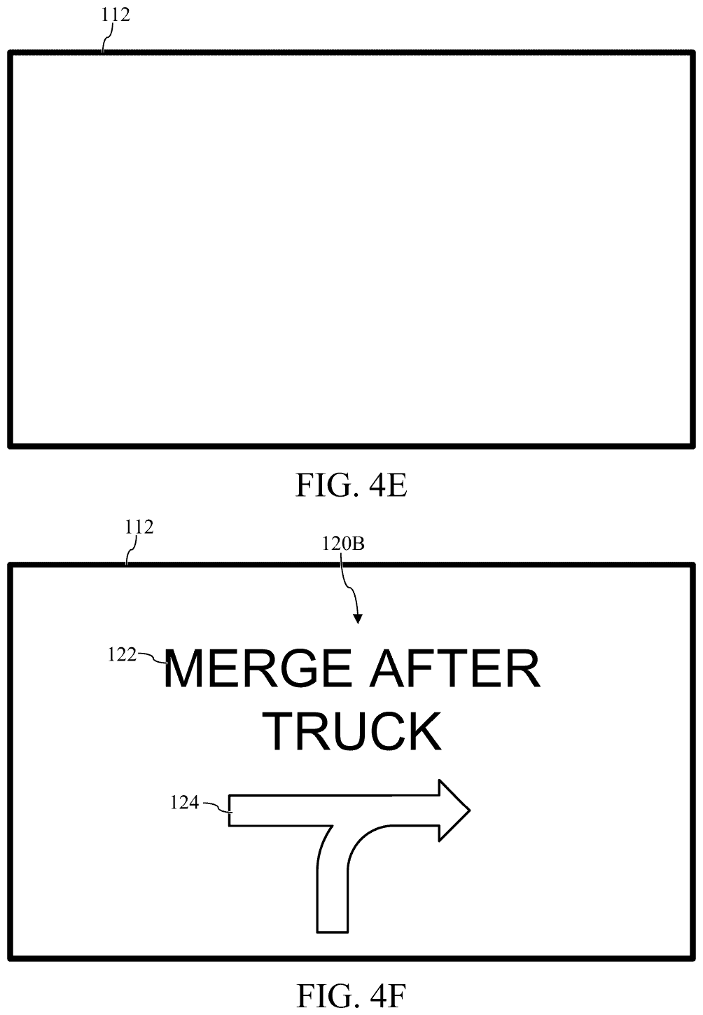

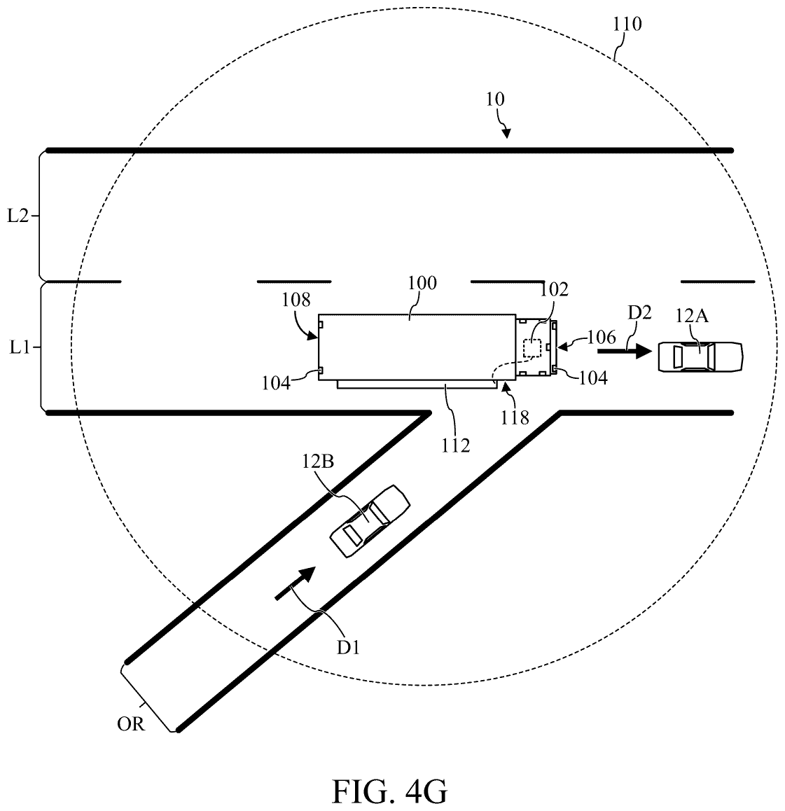

As shown in FIG. 1A, driver vehicle 12B is positioned outside of the predetermined vicinity 110 for display vehicle 100. That is, additional driver vehicle 12B is not identified by sensors 104 of display vehicle 100 based on their position and/or location with respect to display vehicle 100. In the example, sensors 104 will not detect driver data for driver vehicle 12B because driver vehicle 12B is outside of predetermined vicinity 110 defined by sensors 104 of display vehicle 100. In another non-limiting example, driver vehicle 12B can be temporary positioned within predetermined vicinity 110. In this example, sensors 104 can identify driver vehicle 12B and begin detecting driver data for driver vehicle 12B. However, based on the detected driver data, computing device 102 and/or sensors 104 can determine driver vehicle 12B is stationary/parked on on-ramp (OR) of road 10. As such, computing device 102/sensors 104 can cease processing driver data for driver vehicle 12B, as no suitable driver-specific information 120 can/would be presented to parked driver vehicle 12B. As discussed herein, multiple driver vehicles 12A, 12B can be identified by sensors 104 of display vehicle 100 and distinct driver-specific information can be provided to each identified driver vehicles 12A, 12B (see, FIGS. 4A-4G).

Once driver data for driver vehicle 12A is detected, or simultaneous to driver data being continuously detected by sensors 104 of display vehicle 100, the detected driver data for driver vehicle 12A is compared to operational parameters for display vehicle 100. As discussed herein, operational parameters for display vehicle 100 are determined, detected, obtained, and/or calculated by computing device 102 of display vehicle 100. The operational parameters for display vehicle 100 include, but are not limited to, a location of display vehicle 100 on road 10, a direction of travel for display vehicle 100 on road 10, future navigational information for display vehicle 100, traffic patterns surrounding display vehicle 100 on road 10, maps for road 10, the speed/acceleration of moving display vehicle 100, and/or a size of display vehicle 100.

In a non-limiting example, comparing the detected driver data for driver vehicle 12A and operational parameters for display vehicle 100 can also include determining if stayed operation of moving vehicle 100 presents a safety concern for driver vehicle 12A. For example, computing device 102/sensors 104 can detect, determine, and/or calculate the speed/acceleration and direction (D1) of travel of driver vehicle 12, as well as determine and/or obtain the speed/acceleration, location, and direction (D2) of travel of moving vehicle 100. In the example shown in FIG. 1A, and with the driver data and operational parameters, computing device 102 can determine, calculate, and/or estimate that driver vehicle 12 and moving vehicle 100 are likely to collide if none of the driver data and operational parameters change. Where computing device 102 of moving vehicle 100 determines there are unsafe conditions based on the comparing of the driver data and/or the operational parameters (e.g., collision anticipated), at least one operational parameter of display vehicle 100 can be adjusted. For example, where moving vehicle 100 is an autonomous vehicle, and the compared driver data and the operational parameters indicate that driver vehicle 12A and moving vehicle 100 are likely to collide upon driver vehicle 12 merging into first lane (L1), computing device 102 can reduce the speed of display vehicle 100 to allow driver vehicle 12 to safely merge into first lane (L1) in front of display vehicle 100.

Based on the comparison of the detected driver data for driver vehicle 12A and the operational parameters for display vehicle 100, driver-specific information 120 is created. That is, computing device 102 of display vehicle 100 can create driver-specific information 120 for driver vehicle 12A based on the detected driver data and the obtained operational parameters of display vehicle 100. In the non-limiting example shown in FIG. 1A, the created driver-specific information 120 can relate to information and/or instructions on how and when to safely merge into the first lane (L1) with respect to display vehicle 100. In the example, driver-specific information 120 only pertains to driver vehicle 12A as a result of driver vehicle 12A being within the predetermined vicinity 110 of display vehicle 100. Because no driver data was detected by sensors 104 for driver vehicle 12B, computing device 102 of display vehicle 100 does not create driver-specific information for driver vehicle 12B. Although discussed herein as being related to information and/or instructions for safe driving maneuvers (e.g., merging), it is understood that the created driver-specific information can relate, include, and/or pertain to various types of information that can be useful for the driver of driver vehicles 12A, 12B.

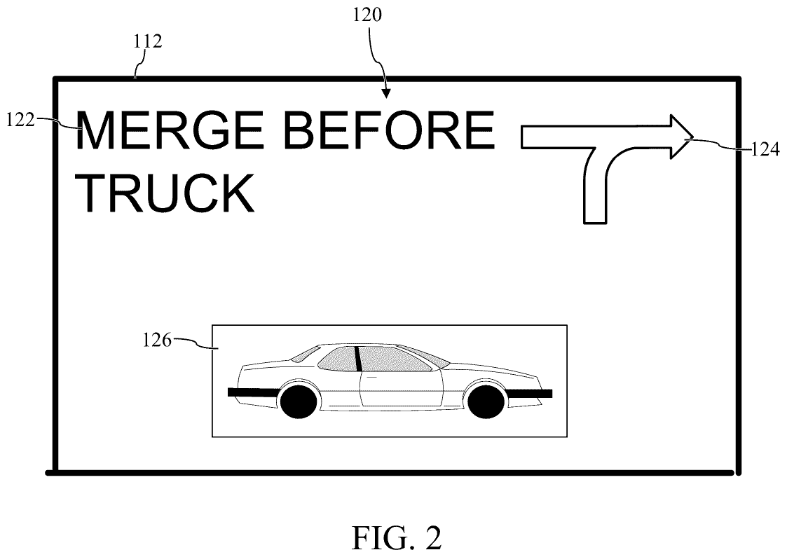

Created driver-specific information is displayed on MVD 112. More specifically, computing device 102 of display vehicle 100 can display the created driver-specific information 120 on MVD 112 of display vehicle 100. In the non-limiting example discussed herein, the created driver-specific information 120 relates to merging instructions for driver vehicle 12A. Turning to FIG. 1B, a non-limiting example of MVD 112 positioned on display vehicle 100 is shown. MVD 112 displays the created driver-specific information 120 so it is visible to driver vehicle 12A. In the example, the created driver-specific information 120 includes text 122 and a symbol 124 that can be displayed to driver vehicle 12A. Text 122 of driver-specific information 120 reads “MERGE BEFORE TRUCK” and symbol 124 of driver-specific information 122 includes a suitable symbol indicating a lane merger. Although only text 122 and symbol 124 form driver-specific information 120 displayed on MVD 112 in FIG. 1B, it is understood that driver-specific information 120 can include additional visuals (e.g., photos, dynamic information) that are beneficial and/or informative for the driver of driver vehicle 12A (see, FIG. 2).

As discussed herein, MVD 112 is formed from a plurality of pixels that have controllable light rays that are adjusted based on a viewing angle of MVD 112 and/or the position of driver vehicle 12A relative to MVD 112 positioned on display vehicle 100. As such, driver-specific information 120 displayed on MVD 112 is only visible to driver vehicle 12A. In order to display driver-specific information 120 on MVD 112 only to driver vehicle 12A, computing device 102 operably coupled to MVD 112 determines display parameters to ensure driver-specific information 120 is visible on MVD 112 for driver vehicle 12A. The determined display parameters for MVD 112 are based, at least in part, on detected driver data for driver vehicle 12A and operational parameters of display vehicle 100. For example, computing device 102 utilizes detected driver data including the size of driver vehicle 12A, speed/acceleration of driver vehicle 12A, the direction (D1) of travel for driver vehicle, etc., as well as operational parameters including the size of display vehicle 100/MVD 112, speed/acceleration of display vehicle 100, the direction (D2) of travel for display vehicle 100, and determines optimized display parameters to ensure driver-specific information 120 is visible on MVD 112 for driver vehicle 12A. Display parameters of MVD 112 include, but are not limited to, emitting angle of the controllable light rays, color of the controllable light rays at the emitting angle, brightness of the controllable light rays at the emitting angle, intensity of the controllable light rays at the emitting angle, and the like.

Turning to FIG. 1C, driver vehicle 12A and display vehicle 100 are shown on road 10 in an advanced or changed position. More specifically, driver vehicle 12A has moved along on-ramp (OR) in direction (D1) closer to first lane (L1), and display vehicle 100 has moved in direction (D2) in first lane (L1) closer to on-ramp (OR). In the example, and as discussed herein, operational parameters, specifically the speed/acceleration, are adjusted (e.g., reduced) for display vehicle 100 to allow driver vehicle 12A to merge into first lane (L1) before or ahead of display vehicle 100. Additionally, as driver vehicle 12A moves along on-ramp (OR) (compare, FIGS. 1A and 1C) toward first lane (L1), MVD 112 of display vehicle 100 can continue to display driver-specific information 120, as similarly shown in FIG. 1B. However, because the driver data/operational parameters of driver vehicle 12A and display vehicle 100 have changed, operational parameters of MVD 112 displaying the driver-specific information 120 are also changed. More specifically, as the position/location, and other driver data/operational parameters (e.g., distance between vehicles) of driver vehicle 12A and display vehicle 100 change over time, display parameters of MVD 112 are adjusted, changed, and/or altered so MVD 112 can continue to display driver-specific information 120 to driver vehicle 12A. As discussed herein, MVD 112 is formed from a plurality of pixels that have controllable light rays that are adjusted based on a viewing angle of MVD 112 and/or the position of driver vehicle 12A relative to MVD 112 positioned on display vehicle 100. As discussed herein, adjusting display parameters of MVD 112 allows for a plurality of driver-specific information to be provided to multiple driver vehicles simultaneously on MVD 112, such that each driver vehicle can only see the driver-specific information that pertains to them.

FIG. 1D depicts driver vehicle 12A and display vehicle 100 advanced further on on-ramp (OR) and first lane (L1) of road 10, respectively. In a non-limiting example, MVD 112 can continuously adjust display parameters of MVD 112 to display driver-specific information 120 to driver vehicle 12A as it gets closer to display vehicle 100 (see, FIG. 1B), until MVD 112 is no longer visible to driver vehicle 12A (see, FIG. 1E). In another non-limiting example, computing device 102 of display vehicle 100 can discontinue displaying driver-specific information 12/adjusting display parameters of MVD 112 when driver vehicle 12A is within a predetermined distance (X) of display vehicle 100. In the non-limiting example, sensors 104 of display vehicle 100 can determine that driver vehicle 12A merging into first lane (L1) is within a predetermined distance (X) and may discontinue displaying driver-specific information 120 on MVD 112. When operation or the displaying is discontinued, MVD 112 can appear blank or “black” to driver vehicle 12A (see, FIG. 4E). Discontinuing to display driver-specific information 120 on MVD 112 once driver vehicle 12A is within a predetermined distance (X) of display vehicle 100 can prevent or minimize a distraction to driver vehicle 12A right before merging into first lane (L1), in front of display vehicle 100.

FIG. 1E depicts driver vehicle 12A driving in a direction (D2) within first lane (L1) after merging in front of display vehicle 100, as instructed by driver-specific information 120 displayed on MVD 112.

FIG. 2 shows another non-limiting example if MVD 112 displaying driver-specific information 120 to driver vehicle 12A. It is understood that similarly numbered and/or named components may function in a substantially similar fashion. Redundant explanation of these components has been omitted for clarity.

In the non-limiting example shown in FIG. 2, driver-specific information 120 displayed on MVD 112 can include text 122 and symbol 124 as previously discussed herein. Additionally, driver-specific information 120 can also include a photo or image 126 of driver vehicle 12A itself. Image 126 included in driver-specific information 12 displayed on MVD 112 can be captured by sensors 104 (e.g., cameras) of display vehicle 100. Image 126 included in driver-specific information 120 can provide additional information, notification, and/or confirmation to the driver of driver vehicle 12A that the instructions included in driver-specific information 120 are for them. In another non-limiting example, computing device 102 of display vehicle 100 can compare images of driver vehicle 100, captured by cameras/sensors 104, to a database of vehicles and determine a make, model, and color of driver vehicle 12A. In this example, driver-specific information 120 can include additional text identifying driver vehicle 12A by make, model, and color (e.g., white-VW-Jetta).

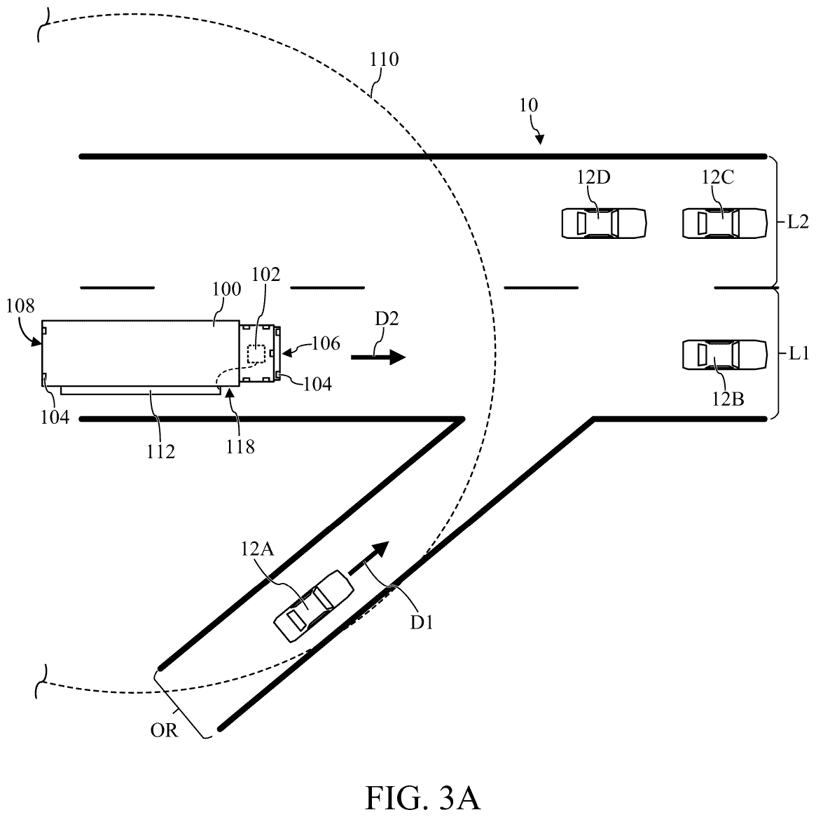

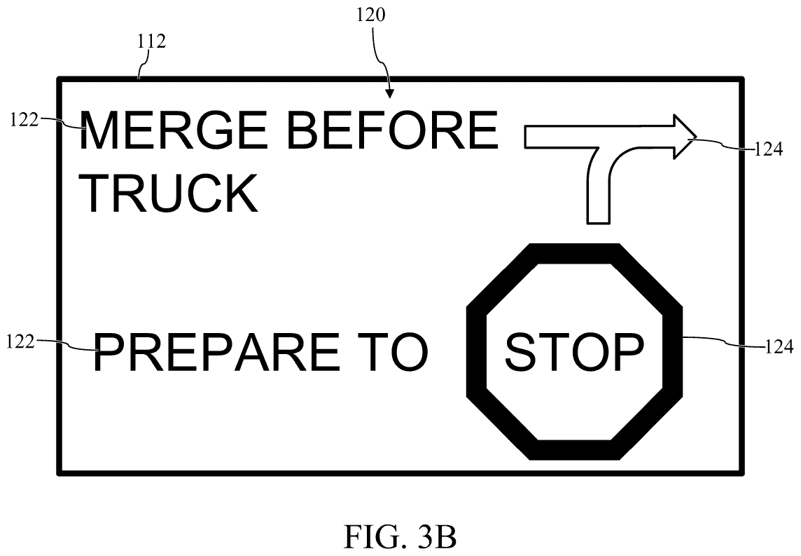

Turning to FIGS. 3A and 3B, another non-limiting example of display vehicle 100 including MVD 112 (FIG. 3A) and driver-specific information 120 displayed on MVD 112 (FIG. 3B) are shown. It is understood that similarly numbered and/or named components may function in a substantially similar fashion. Redundant explanation of these components has been omitted for clarity.

As shown in FIG. 3A, driver vehicle 12A is traveling in a direction (D1) along on-ramp (OR) of road 10, with the intentions to merge into first lane (L1). Additionally, display vehicle 100 is traveling in a direction (D2) in first lane (L1) of road 10. Also shown in the non-limiting example, a plurality of driver vehicles 12B, 12C, 12D are stopped in first lane (L1) and second lane (L2) of road 10, ahead of on-ramp (OR) and display vehicle 100. Display vehicle 100, and computing device 102 included thereon, are configured to create, display, and adjust driver-specific information 120 on MVD 112 of display vehicle 100 for merging driver vehicle 12A as similarly discussed herein with respect to FIG. 1A-1E. In addition to driver data for driver vehicle 12A detected by sensors 104, computing device 102 and/or sensors 104 of display vehicle 100 can also detect driver data and/or operational parameters relating to the stopped traffic (e.g., driver vehicles 12B, 12C, 12D) ahead. For example, based on the GPS system included within or operatively connected to computing device 102, computing device 102 can determine there are a plurality of stopped driver vehicles 12B, 12C, 12D in first lane (L1) and second lane (L2) on road 10, ahead of display vehicle 100. As such, computing device 102 of display vehicle 100 can utilize the data relating to the stopped driver vehicles 12B, 12C, 12D when comparing detected driver data and operational parameters, adjusting operational parameters, creating driver-specific information 120, displaying driver-specific information 120, and/or adjusting display parameters of MVD 112 as similarly discussed herein.

Turning to FIG. 3B, driver-specific information 120 for driver vehicle 12A merging into first lane (L1) in front of display truck 100, and behind stop traffic of driver vehicles 12B, 12C, 12D is shown. As similarly discussed herein, driver-specific information 120 is displayed on MVD 112, such that driver-specific information 120 is visible to driver vehicle 12A as it moves toward and/or in front of display vehicle 100. In the example shown, driver-specific information 120 for driver vehicle 12A includes text 122 and symbols 124. In addition to text 120 and symbols 124 leading to information for safely merging into first lane (L1), driver-specific information 120 display on MVD 112 can include text 122 and symbols 124 indicating a traffic warning. For example, and as shown in FIG. 3B, text 122 of driver-specific information 120 and also can read “PREPARE TO” and symbol 124 can display a stop sign, or any other suitable symbol indicating driver vehicle 12A must come to a stop.

FIG. 4A-4G depict various views display vehicle 100 and driver vehicles 12A, 12B travelling on road 10, and driver-specific information provided on MVD 112 of display vehicle 100. More specifically, FIGS. 4A, 4D, and 4G show aerial views of display vehicle 100 and driver vehicles 12A, 12B traveling along road 10, and FIGS. 4B, 4C, 4E, and 4F depict views of MVD 112 displaying driver-specific information 120A, 120B to each of the respective driver vehicles 12A, 12B. It is understood that similarly numbered and/or named components may function in a substantially similar fashion. Redundant explanation of these components has been omitted for clarity.

As shown in FIG. 4A, sensors 104 and/or computing device 102 of display vehicle 100 can identify and detect driver data for driver vehicle 12A within the predetermined detection vicinity 110, as similarly discussed herein with respect to FIG. 1A. Additionally, computing device 102 and sensors 104 of display vehicle 100 can also identify and continuously detect driver data for driver vehicle 12B. More specifically, driver vehicle 12B is traveling in a direction (D1) along on-ramp (OR) of road 10, behind driver vehicle 12A. Driver vehicle 12B is also positioned or located within predetermined detection vicinity 110 defined by computing device 102 and/or sensors 104 of display vehicle 100. As such, and similar to driver vehicle 12A, computing device 102 and/or sensors 104 of display vehicle 100 can initially identify, and subsequently continuously detect driver data for driver vehicle 12B simultaneous to detecting driver data for driver vehicle 12A. It is understood that driver data detected by computing device 102 and/or sensors 104 is specific to respective driver vehicle 12A, 12B. As such, at least a portion of detected driver data relating to driver vehicle 12A is distinct from the detective driver data relating to driver vehicle 12B (e.g., location, size).

As similarly discussed herein with respect to FIG. 1A, driver data for both driver vehicles 12A, 12B can be compared to operational parameters of display vehicle 100. For example, the location of each driver vehicle 12A, 12B on on-ramp (OR) of road 10, the speed/acceleration of driver vehicles 12A, 12B, and/or the size of driver vehicles 12A, 12B (e.g., driver data) can be compared to the location of display vehicle 100 in first lane (L1) of road 10, the speed/acceleration of display vehicle 100, and/or the size of display vehicle 100 (e.g., operational parameters). In comparing the driver data for driver vehicles 12A, 12B and operational parameters of display vehicle 100, computing device 102 of display vehicle 100 can create driver-specific information 120A, 120B for each driver vehicle 12A, 12B. More specifically, and based on the respective driver data and operational parameters, computing device 102 of display vehicle 100 can create, generate, and/or establish first driver-specific information 120A for driver vehicle 12A, and second driver-specific information 120B for driver vehicle 12B. Depending upon the type of information included within driver-specific information 120A, 120B, at least a portion of second driver-specific information 120B for driver vehicle 12B can be distinct from first driver-specific information 120A for driver vehicle 12A.

As discussed herein, the driver-specific information 120A, 120B is created or generated by computing device 102 for the purposes of providing instructions surrounding safe driving on road 10. Turning to FIGS. 4B and 4C, non-limiting examples of driver-specific information 120A, 120B are shown. More specifically, FIG. 4B shows first driver-specific information 120A for driver vehicle 12A displayed or visually presented on MVD 112, and FIG. 4C shows second driver-specific information 120B for vehicle driver vehicle 12B displayed or visually presented on the same MVD 112. In the example, first driver-specific information 120A includes text 122 and symbols 124 that indicate driver vehicle 12A should merge into first lane (L1) before or in front of display vehicle 100. Second driver-specific information 120B includes text 122 and symbols 124 that indicate driver vehicle 12B should merge into first lane (L1) after or behind display vehicle 100. As discussed herein, the plurality of pixels forming MVD 112 of display vehicle 100 allow both the first driver-specific information 120A and the second driver-specific information 120B to be simultaneously displayed to the respective driver vehicle 12A, 12B. That is and based on the display parameters for the pixels forming MVD 112, driver vehicle 12A is only capable or able to see first driver-specific information 120A on MVD 112, and driver vehicle 12B is only capable or able to see second driver-specific information 120B on MVD 112. The display parameters determined by computing device 102 to achieve the simultaneous displaying of driver-specific information 120A, 120B are also specific to each driver vehicle 12A, 12B and/or based upon driver data specific to each driver vehicle 12A, 12B (e.g., size, speed/acceleration, position, etc.).

As driver vehicles 12A, 12B continue in direction (D1) on on-ramp (OR) with the intentions to merge into first lane (L1), display parameters of MVD 112 can be continuously adjusted in order for driver-specific information 120A, 120B to be displayed to the respective driver vehicles 12A, 12B. Similar processes for adjusting display parameters of MVD 112 to ensure first driver-specific information 120A is visible to vehicle 12A and second driver-specific information 120B is visible to vehicle 12B is discussed herein with respect to FIGS. 1B and 1C.

FIG. 4D shows driver vehicles 12A, 12B and display vehicle 100 advancing in each respective portion of road 10, similar to driver vehicle 12A and display vehicle 100 discussed here and with respect to FIGS. 1C and 1D. In the non-limiting example, driver 12A can be positioned a predetermined distance (X) from display vehicle 100, as detected and/or determined by computing device 102 and/or sensors 104. Conversely, driver vehicle 12B is still positioned within the predetermined detection vicinity 110 but is not positioned or located a predetermined distance (X) from display vehicle 100. In a non-limiting example, because driver vehicle 12A is a predetermined distance of (X) from display vehicle 100, the displaying of first driver-specific information 120A ceases for driver vehicle 12A. However, MVD 112 on display vehicle 100 can continue to display and/or adjust display parameters of MVD 112, in order for second driver-specific information 120B to continue to be displayed to driver vehicle 12B.

FIGS. 4E and 4F show examples of MVD 112 from the perspective of driver vehicle 12A (see, FIG. 4E) and from the perspective of driver vehicle 12B (see, FIG. 4F). In the non-limiting example, and as similar discussed herein with respect to FIG. 1D, because driver vehicle 12A is within the predetermined distance (X) from display vehicle 100, MVD 112 is blank and/or MVD 112 ceases to display first driver-specific information 120A for driver vehicle 12A. However, and as shown in FIG. 4F, MVD 112 can continue to display (and adjust display parameters) second driver-specific information 120B for driver vehicle 12B.

FIG. 4G shows driver vehicles 12A, 12B and display vehicle 100 advancing still further on road 10. In the non-limiting example, driver vehicle 12A is located within first lane (L1), ahead of display vehicle 100, and driver vehicle 12B is still driving in a direction (D1) on on-ramp (OR) of road 10. Driver vehicle 12B, still being visually presented with second driver-specific information 120B is also preparing to merge onto first lane (L1) of road 10, behind display vehicle 100.

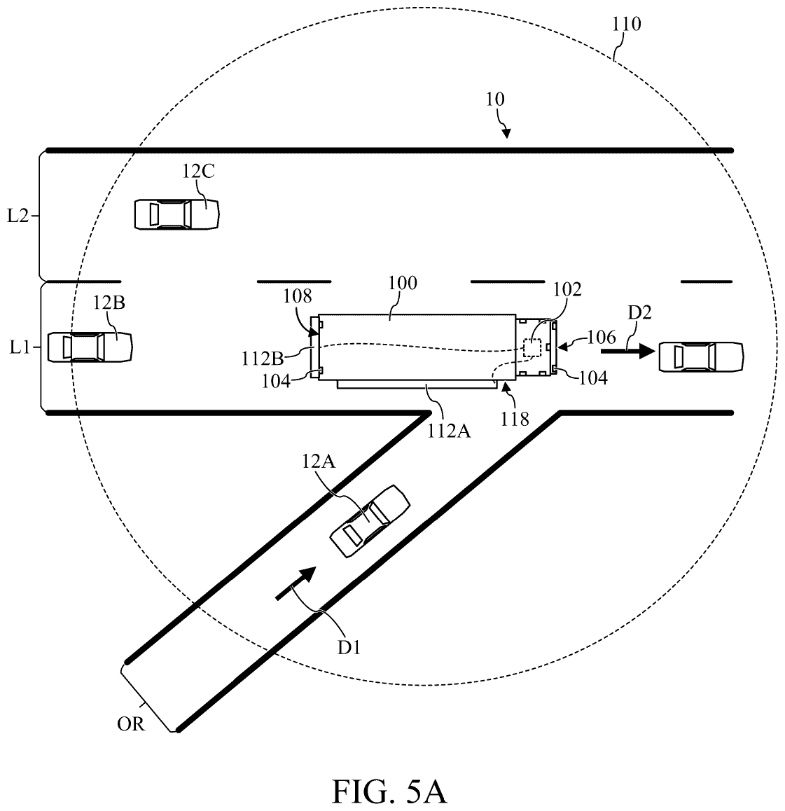

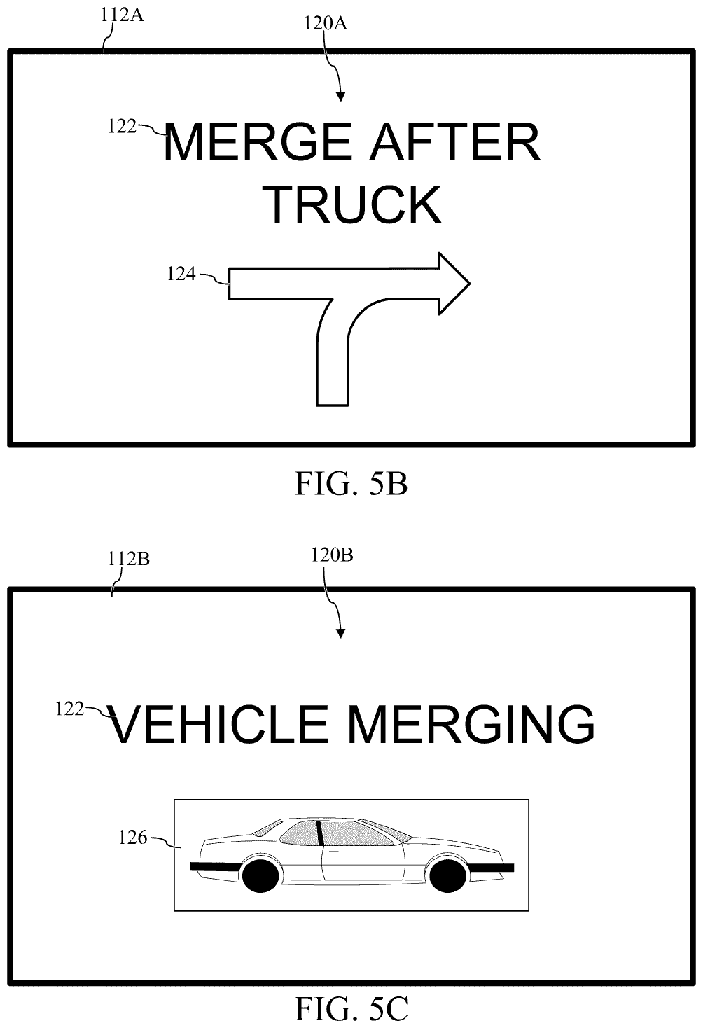

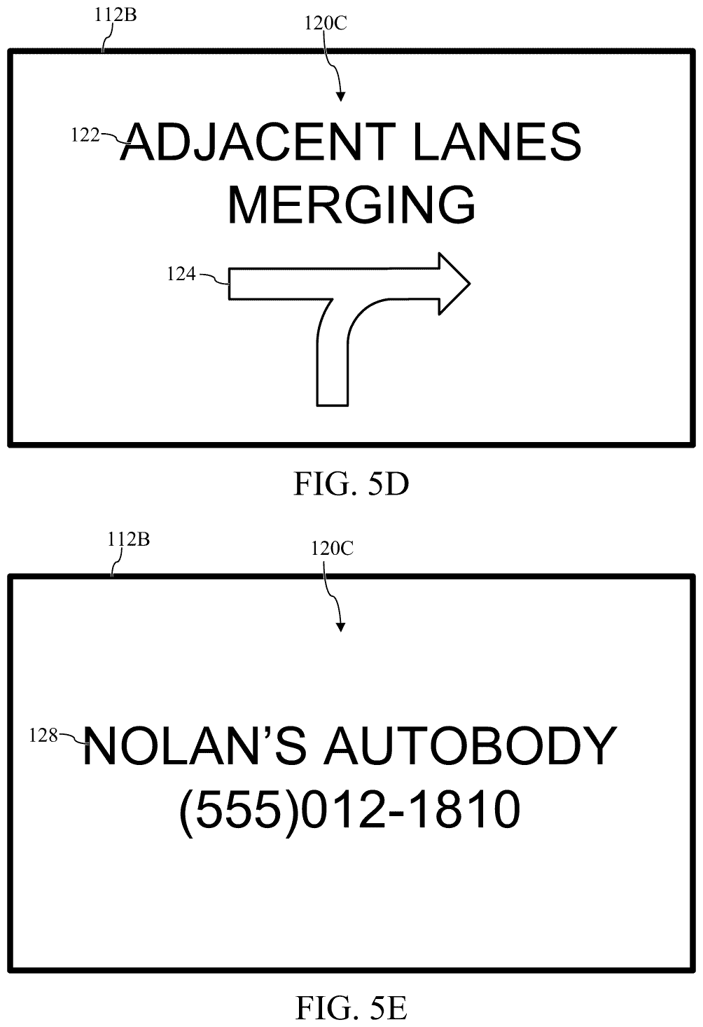

FIGS. 5A-5C depict various views of display vehicle 100 and driver vehicles 12A, 12B, 12C travelling on road 10 (FIG. 5A), and MVDs 112A, 112B on display vehicle 100 (FIGS. 5B-5E) according to another non-limiting example. As shown in FIG. 5A, display vehicle 100 includes a plurality of MVDs 112A, 112B. More specifically, display vehicle 100 includes MVD 112A positioned on side 118, and a distinct MVD 112B positioned on back end 108 of display vehicle 100, proximate MVD 112A. In the non-limiting example, MVDs 112A, 112B are each operably coupled to computing device 102 of display vehicle 100.

As similarly discussed herein, computing device 102 and/or sensors 104 can identify driver vehicles 12A, 12B, 12C located or positioned within predetermined vicinity 110, and subsequently continuously detect driver data relating to each driver vehicle 12A, 12B, 12C, for displaying driver-specific information 120A, 120B, 120C to each driver vehicle 12A, 12B, 12C. In the non-limiting example, first driver-specific information 120A can be displayed on MVD 112A for driver vehicle 12A (see, FIG. 5B). Driver vehicle 12B positioned behind display vehicle 100 can be provided second driver-specific information 120B on MVD 112B. More specifically, after detecting driver data for all driver vehicles 12A, 12B, 12C and comparing the driver data to operational parameters of display vehicle 100, computing device 102 can create and/or generate second driver-specific information 120B for driver vehicle 12B to be displayed on MVD 112B positioned on back end 108 of display vehicle 100. Briefly turning to FIG. 5C, second driver-specific information 120B visually presented to driver vehicle 12B on MVD 112B is provided with text 122 and image 126 indicating driver vehicle 12A is merging into first lane (L1). With second driver-specific information 120B displayed and/or visually presented to driver vehicle 12B, the pilot or operator of driver vehicle 12B can decide whether to adjust operational parameters of the vehicle in anticipation of driver vehicle 12A merging into first lane (L1). Once driver vehicle 12A merges into first lane (L1), and sensors 104 detect driver vehicle 12A has merged, MVD 112B can discontinue displaying second driver-specific information to driver vehicle 12B.

Based on driver vehicle 12C also being positioned within predetermined vicinity 110, and driver data being detected by computing device 102 and/or sensors 104 for driver vehicle 12C, computing device 102 can also create and/or generate third driver-specific information 120C for driver vehicle 12C. In the example, computing device 102, via sensors 104, determines driver vehicle 12C is positioned behind display vehicle 100 and in second lane (L2) of road 10. As such, third driver-specific information 120C is presented to driver vehicle 12C on MVD 112B, simultaneous to second driver-specific information 120B being visually presented to driver vehicle 12B.

Turning to FIGS. 5D and 5E, non-limiting examples of third driver-specific information 120C are shown. Specifically, each of FIGS. 5D and 5E depict MVD 112B displaying an example of third driver-specific information 120C to driver vehicle 12C. In the first example, third driver-specific information 120C includes text 122 and symbol(s) 124 notifying and/or informing driver vehicle 12C that adjacent lanes (e.g., first lane (L1), on-ramp (OR)) are merging. This information provides driver vehicle 12C with a warning that vehicles in other lanes potentially can change lanes in front of or behind driver vehicle 12C. In another example the notification of lanes merging can be insignificant or unnecessary to warn driver vehicle 12C. In this example, and as shown in FIG. 5E, third driver-specific information 120C can include a paid advertisement 128.

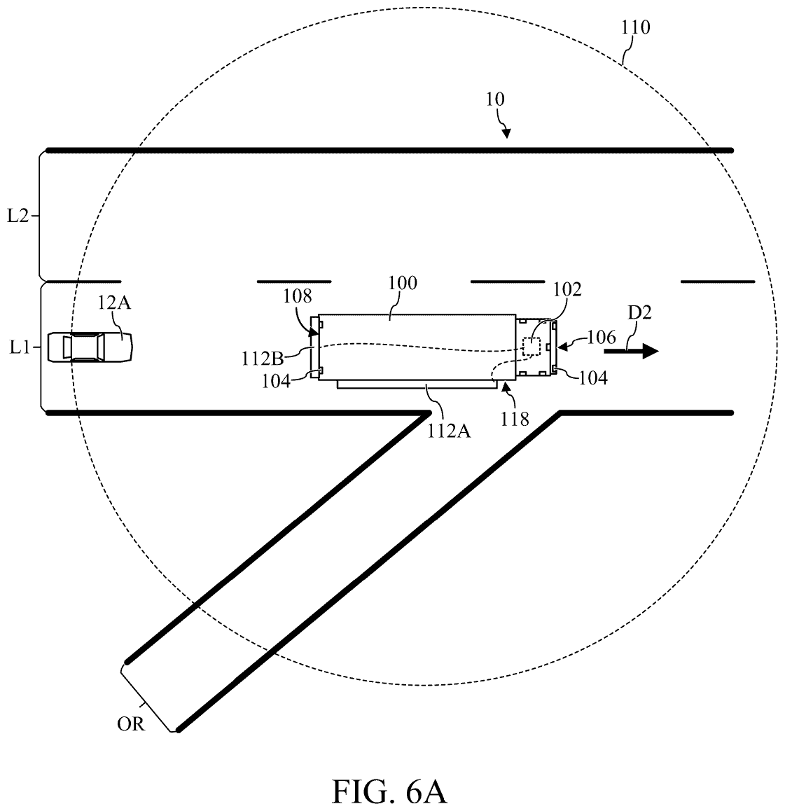

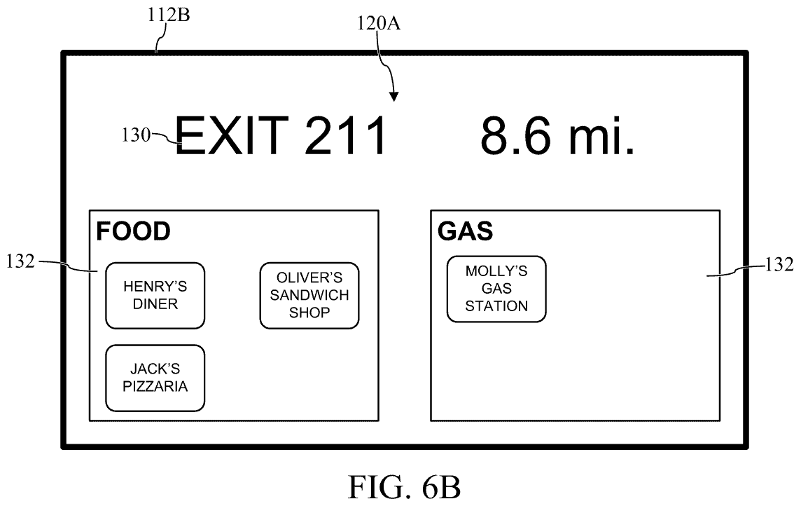

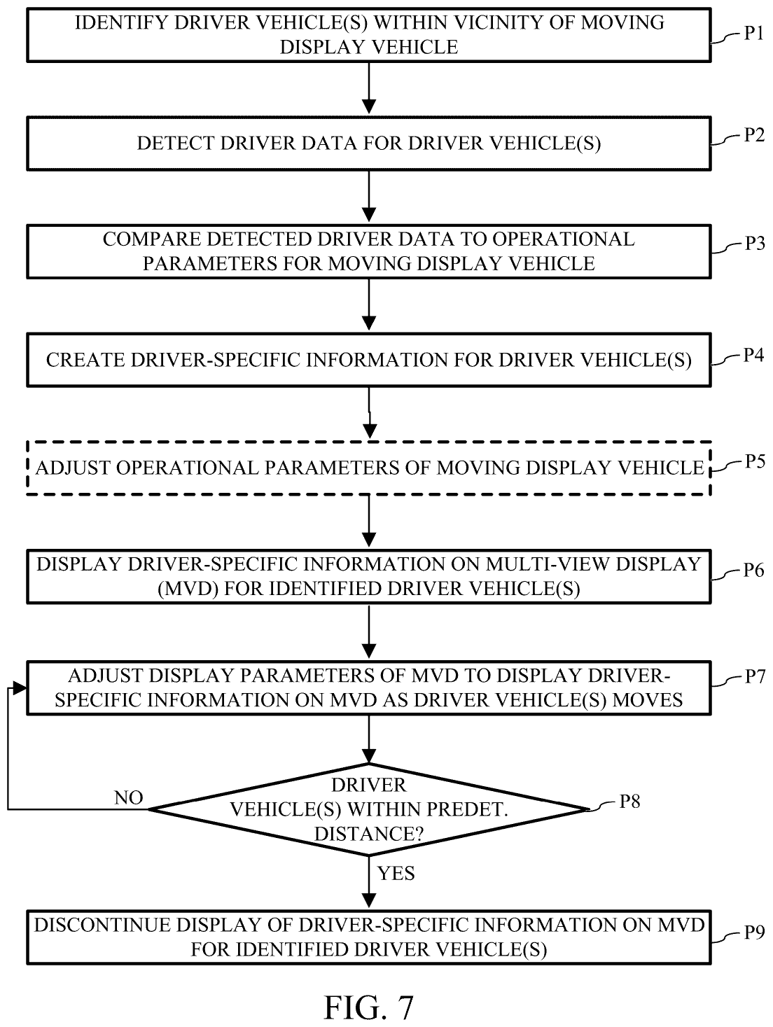

FIG. 6A shows an aerial view of road 10 including driver vehicle 12A and display vehicle 100, and FIG. 6B shows MVD 112B of display vehicle displaying driver-specific information 120A for driver vehicle 12A, as similarly discussed herein. In the example shown in FIG. 6A, no other driver vehicles are present or located within predetermined vicinity 110 for display vehicle 100. As such, computing device 102 can create or generate driver-specific information 120A that relates to road 10, and display driver-specific information 120A on MVD 112B for driver vehicle 12A. For example, and turning to FIG. 6B, driver-specific information 120A can include dynamic text 130, 132 that changes based on detected driver data for driver vehicle 12A and/or operational parameters of display vehicle 100. In the non-limiting example shown in FIG. 7B, dynamic text 130 provides information relating to the next closest exit including the exit number (e.g., “EXIT 211”) and the distance to that exit (e.g., “8.6 mi.”). As driver vehicle 12A and display vehicle 100 travel along road 10 in direction (D2), the distance to the displayed exit included in dynamic text 130 can change (e.g., reduce), until display vehicle 100 reaches the exit. Once the exit is passed dynamic text 130 included in driver-specific information 120A is adjusted, updated, and/or altered to display the next exit number and the distance to that exit (e.g., “EXIT 212”, “11.0 mi.”). For a distinct driver vehicle (not shown) positioned 0.1 mi. behind driver vehicle 12A, but still within predetermined vicinity 110 of display vehicle 100, driver-specific information for the distinct driver vehicle can include a distinct distance to the indicated exit (e.g., +0.1 mi. than driver-specific information 120A). Dynamic text 132 of driver-specific information can display services offered at the indicated exit (e.g., Food, Gas, etc.), and will also dynamically change or update upon passing the indicated exit and reflect services for the subsequent exit. Information included in dynamic text 130, 132 for driver-specific information 120A can be stored within computing device 102, with GPS system, and/or can be retrieved via a storage device in communication with computing device 102.

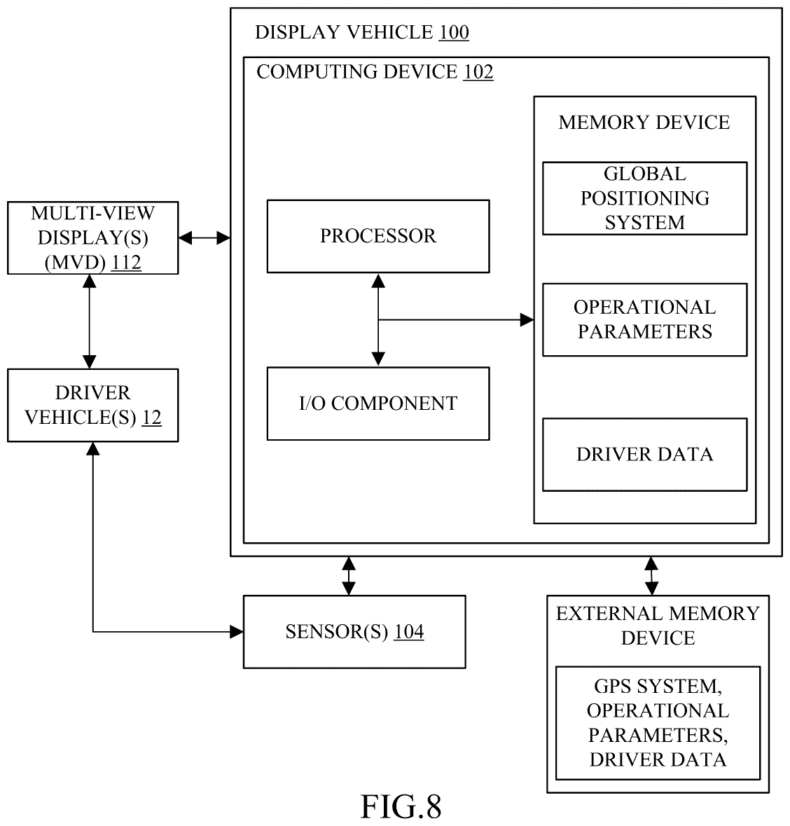

FIG. 7 shows example processes for providing information to a driver vehicle. Specifically, FIG. 7 shows a flowchart depicting one example process providing driver-specific information to a driver of a vehicle using a multi-view display (MVD) included on a moving display vehicle. In some cases, the processes can be performed using display vehicle 100, as discussed above with respect to FIGS. 1A-6B, and computing system including computing device 102 shown and discussed herein with respect to FIG. 8.

In process P1 driver vehicle(s) are identified. More specifically, at least one driver vehicle is identified via a plurality of sensors positioned on a display vehicle. The at least one driver vehicle is identified as traveling, located, and/or positioned within a predetermined vicinity of the display vehicle, where the predetermined vicinity is defined by the at least one sensors of the display vehicle. Where more than one driver vehicle is identified, identifying includes identify a first driver vehicle traveling within the predetermined vicinity of the moving display vehicle, and identifying a second driver vehicle traveling within the predetermined vicinity of the moving display vehicle.

In process P2 driver data is detect for the driver vehicle(s). More specifically, the sensor(s) and/or a computing device of the moving display vehicle continuously detect driver data for the identified driver vehicle(s). Where more than one driver vehicle is identified, detecting in process P2 can also include detecting driver data for the first driver vehicle, and detecting driver data for the second driver vehicle, where at least a portion of the driver data for the second driver vehicle is distinct from the driver data for the first driver vehicle. In non-limiting examples, the driver data detected for identified driver vehicles include, but are not limited to, a location of the at least one identified driver vehicle, a direction of travel for the at least one identified driver vehicle, a speed of the at least one identified driver vehicle, acceleration of the at least one identified driver vehicle, or a size of the at least one identified driver vehicle.

In process P3, detected driver data for driver vehicle(s) are compared to operational parameters for the moving display vehicle. Where more than one driver vehicle is identified, detected driver data for each identified driver vehicle is compared to operational parameters for the moving display vehicle. In non-limiting examples, operational parameters for the display vehicle include, but are not limited to, a location of the moving display vehicle, a direction of travel for the moving display vehicle, future navigational information for the moving display vehicle, traffic patterns surrounding the moving display vehicle, maps for a roadway traveled on by the moving display vehicle and the at least one identified driver vehicle, a speed of the moving display vehicle, an acceleration of the moving display vehicle, or a size of the moving display vehicle.

In process P4, driver-specific information is created. More specifically, driver-specific information is created for driver vehicles. In an example where more than one driver vehicle is identified, driver-specific information is created for and/or is associated with each driver vehicle identified as being with the predetermined vicinity of the moving display vehicle (e.g., process P1). The created, driver-specific information is based on the comparing of the detected driver data for the driver vehicle(s) and the operational parameters for the moving display vehicle.

In process P5 (shown in phantom as optional), operational parameters of the moving display vehicle are adjusted. More specifically, and in response to comparing the detected driver data for the identified driver vehicle(s) and the operational parameters of the moving display vehicle, at least one operational parameters of the display vehicle are adjusted.

In process P6, driver-specific information is displayed to the driver vehicle(s). More specifically, created, driver-specific information for driver vehicle(s) is displayed on a multi-view display (MVD) positioned on the moving display vehicle. Where multiple driver vehicles are identified in process P1, and driver-specific information is created for each of the multiple driver vehicles, the displaying in process P6 can include visually presenting first driver-specific information the MVD for the first driver vehicle, and (simultaneously) visually presenting the second driver-specific information on the MVD for the second driver vehicle. In the example, the first driver-specific information is only visible to the first driver vehicle, and the second driver-specific information is only visible to the second driver vehicle. In another non-limiting example where the moving display vehicle includes multiple MVDS, the displaying process of P6 can include visually presenting first driver-specific information the MVD for the first driver vehicle, and (simultaneously) visually presenting the second driver-specific information on a distinct MVD for the second driver vehicle. In the example, the first driver-specific information is only visible to the first driver vehicle, and the second driver-specific information is only visible to the second driver vehicle.

In process P7, display parameters of MVD are adjusted. More specifically, display parameters of MVD position of the moving display vehicle are adjusted to continuously display driver-specific information on the MVD to identified driver vehicle(s) as they move relative to the display vehicle. Where multiple driver vehicles are identified, distinct display parameters of MVD are adjusted to continuously display the first driver-specific information to the first driver vehicle, while simultaneously displaying the second driver-specific information to the second driver vehicle as both driver vehicles move relative to the moving display vehicle. In non-limiting examples, display parameters of the MVD include, but are not limited to, emitting angle of the controllable light rays, color of the controllable light rays at the emitting angle, brightness of the controllable light rays at the emitting angle, intensity of the controllable light rays at the emitting angle, and the like.

In process P8 it is determined if driver vehicle(s) are within a predetermined distance of the moving display vehicle. More specifically and based on continuously detected driver data for the identified driver vehicle(s), it is determined if the driver vehicle(s) is within a predetermined distance of the moving display vehicle including the MVD displaying the driver-specific information. If it is determined the identified driver vehicle is not within the predetermined distance (e.g., “NO” at process P8), the display parameters of MVD may be continuously adjusted to display the driver-specific information to the driver vehicle. If, however it is determined that the identified driver vehicle is within the predetermined distance of the moving display vehicle (e.g., “YES” at process P8), the display of the driver-specific information is discontinued or ceases to be displayed on MVD for the identified driver vehicle (e.g., process P9).

FIG. 8 depicts a schematic view of a computing environment or system (hereafter, “computing system”), and the various components included within computing system. In the non-limiting example shown in FIG. 8, computing system is included within display vehicle 100 and includes at least one computing device 102 that is configured to provide driver-specific information to driver vehicles (see e.g., FIGS. 1A-6B) by performing the processes P1-P9 discussed herein with respect to FIG. 7. It is understood that similarly numbered and/or named components can function in a substantially similar fashion. Redundant explanation of these components has been omitted for clarity.

Computing device 102 includes a processor, and a memory device. The processor is coupled to the memory device via a system bus. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device includes one or more devices that enable information, such as executable instructions or other data (e.g., driver data, operational parameters), to be stored and retrieved. Moreover, the memory device includes one or more computer readable media, such as, without limitation, dynamic random access memory (DRAM), static random access memory (SRAM), a solid state disk, or a hard disk. In the example embodiment, the memory device stores, without limitation, application source code, application object code, configuration data, additional input events, application states, assertion statements, validation results, or any other type of data. For example, operational modules, electronic information, and/or data relating to global positioning system (GPS), operational parameters for display vehicle 100, and the detected driver data for the identified driver vehicles 12 are stored within the memory device. The operational modules, information, and/or data can include the required information and/or can allow computing system, and specifically computing device 102, to perform the processes discussed herein for providing driver-specific information to a driver vehicle 12 using multi-view display(s) 112.

In the example embodiment, processor may be programmed by encoding an operation using one or more executable instructions and providing the executable instructions in the memory device. In the example embodiment, the processor is programmed to select a plurality of measurements that are received from data acquisition devices (e.g., sensors 104).

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Computing system, and specifically computing device 102 of computing system, can also be in communication with external memory device. External memory device is configured to store various modules, data and/or electronic information relating to various other aspects of computing system, similar to memory device of computing device(s) 102. Additionally, external memory device is configured to share (e.g., send and receive) data and/or electronic information with computing device(s) 102 of computing system. In the non-limiting example shown in FIG. 8, external memory device can include any or all of the operational modules and/or data shown to be stored in memory device (e.g., GPS, operational parameters, etc.). In a non-limiting example, external memory device is a cloud-based storage component or system.

Computing system can include, for example, at least one input/output (I/O) component(s) (including a keyboard, touchscreen, or monitor display), and a communications pathway. I/O component can comprise one or more human I/O devices, which enables user (e.g., display vehicle driver/operator) to interact with computing device(s) 102 to provide driver-specific information for driver vehicle(s), as discussed herein. Computing device(s) 102 can also be implemented in a distributed manner such that different components reside in different physical locations.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

The terminology used herein is for the purpose of describing particular examples only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance can or cannot occur, and that the description includes instances where the event occurs and instances where it does not.

Approximating language, as used herein throughout the specification and claims, is applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language can correspond to the precision of an instrument for measuring the value. Here and throughout the specification and claims, range limitations are combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, can indicate +/−10% of the stated value(s).

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for providing driver-specific information to a driver of a vehicle, the method comprising:
identifying, via at least one sensor positioned on a moving display vehicle, at least one driver vehicle traveling within a predetermined vicinity of the moving display vehicle;
continuously detecting, via the at least one sensor positioned on the moving display vehicle, driver data for the at least one identified driver vehicle;
comparing the continuously detected driver data for the at least one identified driver vehicle to operational parameters for the moving display vehicle;
creating the driver-specific information for the at least one identified driver vehicle based on the comparing of the continuously detected driver data for the at least one identified drive vehicle and the operational parameters for the moving display vehicle;
displaying the driver-specific information on a multi-view display (MVD) positioned on the moving display vehicle for the at least one identified driver vehicle; and
adjusting display parameters of the MVD to display the driver-specific information on the MVD as the at least one identified driver vehicle moves relative to the moving display vehicle.

2. The method of claim 1, further comprising:
adjusting at least one of the operational parameters of the moving display vehicle in response to the comparing of the continuously detected driver data for the at least one identified driver vehicle and the operational parameters for the moving display vehicle.

3. The method of claim 1, wherein the identifying of the at least one driver vehicle further includes:
identifying, via the at least one sensor positioned on the moving display vehicle, a first driver vehicle traveling within the predetermined vicinity of the moving display vehicle, the first driver vehicle having first driver data; and
identifying, via the at least one sensor positioned on the moving display vehicle, a second driver vehicle traveling within the predetermined vicinity of the moving display vehicle, the second driver vehicle having second driver data, distinct from the first driver data.

4. The method of claim 3, wherein the creating of the driver-specific information further includes:
generating first driver-specific information for the first driver vehicle based on the comparing of continuously detected first driver data for the first drive vehicle and the operational parameters for the moving display vehicle; and
generating second driver-specific information for the second driver vehicle based on the comparing of continuously detected second driver data for the second drive vehicle and the operational parameters for the moving display vehicle.

5. The method of claim 4, wherein the displaying of the driver-specific information further includes:
visually presenting the first driver-specific information on the MVD positioned on the moving display vehicle for the first driver vehicle; and
visually presenting the second driver-specific information the MVD positioned on the moving display vehicle for the second driver vehicle,
wherein the first driver-specific information is only visible to the first driver vehicle, and the second driver-specific information is only visible to the second driver vehicle.

6. The method of claim 4, wherein the displaying of the driver-specific information further includes:
visually presenting the first driver-specific information on the MVD positioned on the moving display vehicle for the first driver vehicle; and
visually presenting the second driver-specific information on a distinct MVD positioned on the moving display vehicle for the second driver vehicle, the distinct MVD positioned proximate to the MVD.

7. The method of claim 1, wherein:
the driver data for the at least one identified driver vehicle includes at least one of:
a location of the at least one identified driver vehicle,
a direction of travel for the at least one identified driver vehicle,
a speed of the at least one identified driver vehicle,
acceleration of the at least one identified driver vehicle, or
a size of the at least one identified driver vehicle; and
the operational parameters for the moving display vehicle includes at least one of:
a location of the moving display vehicle,
a direction of travel for the moving display vehicle,
future navigational information for the moving display vehicle,
traffic patterns surrounding the moving display vehicle,
maps for a roadway traveled on by the moving display vehicle and the at least one identified driver vehicle,
a speed of the moving display vehicle, or
a size of the moving display vehicle.

8. A computer program product stored on a non-transitory computer-readable storage medium, which when executed by a computing system, provides driver-specific information to a driver of a vehicle, the computer program product comprising program code for:
identifying, via at least one sensor positioned on a moving display vehicle, at least one driver vehicle traveling within a predetermined vicinity of the moving display vehicle;
continuously detecting, via the at least one sensor positioned on the moving display vehicle, driver data for the at least one identified driver vehicle;
comparing the continuously detected driver data for the at least one identified driver vehicle to operational parameters for the moving display vehicle;
creating driver-specific information for the at least one identified driver vehicle based on the comparing of the continuously detected driver data for the at least one identified drive vehicle and the operational parameters for the moving display vehicle;
displaying the driver-specific information on a multi-view display (MVD) positioned on the moving display vehicle for the at least one identified driver vehicle; and
adjusting display parameters of the MVD to display the driver-specific information on the MVD as the at least one identified driver vehicle moves relative to the moving display vehicle.

9. The computer program product of claim 8, further comprises program code for:
adjusting at least one of the operational parameters of the moving display vehicle in response to the comparing of the continuously detected driver data for the at least one identified driver vehicle and the operational parameters for the moving display vehicle.

10. The computer program product of claim 8, wherein the identifying of the at least one driver vehicle further includes:
identifying, via the at least one sensor positioned on the moving display vehicle, a first driver vehicle traveling within the predetermined vicinity of the moving display vehicle, the first driver vehicle having first driver data; and
identifying, via the at least one sensor positioned on the moving display vehicle, a second driver vehicle traveling within the predetermined vicinity of the moving display vehicle, the second driver vehicle having second driver data, distinct from the first driver data.

11. The computer program product of claim 10, wherein the creating of the driver-specific information further includes:
generating first driver-specific information for the first driver vehicle based on the comparing of continuously detected first driver data for the first drive vehicle and the operational parameters for the moving display vehicle; and
generating second driver-specific information for the second driver vehicle based on the comparing of continuously detected second driver data for the second drive vehicle and the operational parameters for the moving display vehicle.

12. The computer program product of claim 11, wherein the displaying of the driver-specific information further includes:
visually presenting the first driver-specific information on the MVD positioned on the moving display vehicle for the first driver vehicle; and
visually presenting the second driver-specific information the MVD positioned on the moving display vehicle for the second driver vehicle,
wherein the first driver-specific information is only visible to the first driver vehicle, and the second driver-specific information is only visible to the second driver vehicle.

13. The computer program product of claim 11, wherein the displaying of the driver-specific information further includes:
visually presenting the first driver-specific information on the MVD positioned on the moving display vehicle for the first driver vehicle; and
visually presenting the second driver-specific information on a distinct MVD positioned on the moving display vehicle for the second driver vehicle, the distinct MVD positioned proximate to the MVD.

14. The computer program product of claim 8, wherein:
the driver data for the at least one identified driver vehicle includes at least one of:
a location of the at least one identified driver vehicle,
a direction of travel for the at least one identified driver vehicle,
a speed of the at least one identified driver vehicle,
acceleration of the at least one identified driver vehicle, or
a size of the at least one identified driver vehicle; and
the operational parameters for the moving display vehicle includes at least one of:
a location of the moving display vehicle,
a direction of travel for the moving display vehicle,
future navigational information for the moving display vehicle,
traffic patterns surrounding the moving display vehicle,
maps for a roadway traveled on by the moving display vehicle and the at least one identified driver vehicle,
a speed of the moving display vehicle, or
a size of the moving display vehicle.

15. A system comprising:
a moving display vehicle including:
a plurality of sensors positioned on an exterior of the display vehicle; and
a multi-view display (MVD) positioned on the moving display vehicle; and
at least one computing device operably coupled to the plurality of sensors and the MVD of the moving display vehicle, the at least one computing device configured to provide driver-specific information to a driver of a vehicle by performing processes including:
identifying, via the plurality of sensors of the moving display vehicle, at least one driver vehicle traveling within a predetermined vicinity of the moving display vehicle;
continuously detecting, via the plurality of sensors positioned on the moving display vehicle, driver data for the at least one identified driver vehicle;
comparing the continuously detected driver data for the at least one identified driver vehicle to operational parameters for the moving display vehicle;
creating the driver-specific information for the at least one identified driver vehicle based on the comparing of the continuously detected driver data for the at least one identified drive vehicle and the operational parameters for the moving display vehicle;
displaying the driver-specific information on the MVD positioned on the moving display vehicle for the at least one identified driver vehicle; and
adjusting display parameters of the MVD to display the driver-specific information on the MVD as the at least one identified driver vehicle moves relative to the moving display vehicle.

16. The system of claim 15, wherein processes performed by the at least one computing device to provide the driver-specific information to the driver of the vehicle further includes:
adjusting at least one of the operational parameters of the moving display vehicle in response to the comparing of the continuously detected driver data for the at least one identified driver vehicle and the operational parameters for the moving display vehicle.

17. The system of claim 15, wherein the at least one computing device is configured to identify the at least one driver vehicle by performing processes including:
identifying, via the plurality of sensors positioned on the moving display vehicle, a first driver vehicle traveling within the predetermined vicinity of the moving display vehicle, the first driver vehicle having first driver data; and
identifying, via the plurality of sensors positioned on the moving display vehicle, a second driver vehicle traveling within the predetermined vicinity of the moving display vehicle, the second driver vehicle having second driver data, distinct from the first driver data.

18. The system of claim 17, wherein the at least one computing device is configured to create the driver-specific information by performing processes including:
generating first driver-specific information for the first driver vehicle based on the comparing of continuously detected first driver data for the first drive vehicle and the operational parameters for the moving display vehicle; and
generating second driver-specific information for the second driver vehicle based on the comparing of continuously detected second driver data for the second drive vehicle and the operational parameters for the moving display vehicle.

19. The system of claim 18, wherein the at least one computing device is configured to display the driver-specific information by performing processes including:
visually presenting the first driver-specific information on the MVD positioned on the moving display vehicle for the first driver vehicle; and
visually presenting the second driver-specific information the MVD positioned on the moving display vehicle for the second driver vehicle,
wherein the first driver-specific information is only visible to the first driver vehicle, and the second driver-specific information is only visible to the second driver vehicle.

20. The system of claim 18, wherein the at least one computing device is configured to display the driver-specific information by performing processes including:
visually presenting the first driver-specific information on the MVD positioned on the moving display vehicle for the first driver vehicle; and
visually presenting the second driver-specific information on a distinct MVD positioned on the moving display vehicle for the second driver vehicle, the distinct MVD positioned proximate to the MVD.
